(19) United States
(12) Patent Application Publication
(10) Pub. No.: US 2011/0049844 A1
(43) Pub. Date: Mar. 3, 2011

(54) Skeleton length adjustment structure of grip for baby stroller

(76) Inventor: Pao-Hsien Cheng, Tainan Hsien (TW)

(21) Appl. No.: 12/585,070

(22) Filed: Sep. 2, 2009

(51) Int. Cl. B62B 9/20

(52) U.S. Cl. 280/658

(57) ABSTRACT

This invention relates to a skeleton length adjustment structure of grip for baby stroller in which several adjusting holes are provided at each end of the skeleton body, each grip sleeve being provided with an adjustment interlocking knobs which can be arrested in anyone adjusting hole. Each adjustment interlocking knob has a press portion extending out of the grip sleeve and an interlocking portion for being arrested in anyone adjusting hole. A fixing seat is provided at one side of the interlocking portion, and an elastic element generating a force for urging the fixing seat and the adjustment interlocking knob outwardly is provided therebetween. Thus, adjustment of the grip sleeves inserted on the desired position on the skeleton body becomes easier and firmer by the design of disposing the interlocking portion of each adjustment interlocking knob within the fixing seat and of providing an elastic element therebetween.

### BACKGROUND OF THE INVENTION

1. Field of the Invention

The present invention relates to a skeleton length adjustment structure of grip for baby stroller, especially to a novel skeleton length adjustment structure of grip for baby stroller, wherein the length of the grip skeleton can be regulated according to individual height such that the height after regulation is a comfortable height conforming to ergonomics during the gripping of user's hand on the grip sleeve.

2. Brief Description of the Prior Art

Taking baby to outdoor in early stage is either by embracing baby or by carry baby on back. Although baby's weight is in the endurable range of parent and is a sweet load as well, embracing baby or carrying baby on back for a long time often not only causes body fatigue but also induces improper posture or other body damage. It is this reason that the concerned industries have developed baby stroller, which is pushed by parent for carrying baby seated thereon, by which not only baby can sit snugly but also parent gets more relaxed and becomes easier. The baby stroller is usually classified into a variety of categories according to the difference of function so as to cope with different demands coming from various users.

No matter whether the baby stroller belongs to which category, its structure substantially has to comprise a skeleton, grips provided on the upper end of the skeleton, a seat provide on the middle segment of the skeleton, and wheels provided on the lower ends of the skeleton.

In conventional baby stroller currently seen on the market, the structure of its grips, as shown in FIG. 8, has grip sleeves (4) inserted and fixed at the upper ends of the skeleton (3) so that users can grip with their hands on the grip sleeves (4) for pushing the baby stroller to move. However, every user has different height and the user pushing the baby stroller is not confined as some specific person who maybe father or mother. As the height of the baby stroller is fixed after unfolding, the height may not be the best height for the person to push comfortably. After pushing the baby carriage for a long time, the shoulders, neck or arms will suffered from muscular pain or hurt or fatigue.

### SUMMARY OF THE INVENTION

The object of the present invention is to provide a skeleton length adjustment structure of grip for baby stroller, which is essentially to adjust the length of the grip skeleton by the above design of skeleton length adjustment structure, and furthermore to change the distance between the grip sleeves of the grip skeleton and ground. Therefore, the height becomes a comfortable height conforming to ergonomics during the gripping of user's hand on the grip sleeves. Especially, adjustment of the grip sleeves inserted on the desired positions on the skeleton body becomes easier and firmer by the design of disposing the interlocking portions of the adjustment interlocking knobs within the fixing seats and providing elastic elements therebetween.

In order to achieve above object, the skeleton length adjustment structure of grip for baby stroller of the present invention comprises a plurality of adjusting holes provided at the ends of the skeleton body of the grip skeleton, an adjustment interlocking knob being provided on each grip sleeve, each adjustment interlocking knob is arrested in different adjusting hole provided on the skeleton body so as to adjust the position of the grip sleeve inserted on the skeleton body, furthermore to achieve the goal of changing the length of the whole grip skeleton so as to cope with various height of users pushing the baby stroller.

The adjustment interlocking knob of the present invention is inserted and fixed on each grip sleeve, and a fixing seat is provided on another side wall surface of each grip sleeve inserted and fixed by the adjustment interlocking knob, and an elastic element generating a force for urging the fixing seat and the adjustment interlocking knob outwardly is provided therebetween. Further, each adjustment interlocking knob has a press portion extending out of the grip sleeve for pressing by users, and an interlocking portion provided at the other end of the press portion for being arrested into any one adjusting hole on the skeleton body. Furthermore, two adjacent adjusting holes are connected by a connecting groove the width of which is larger than that of the press portion of the adjustment interlocking knob and smaller than the width of its interlocking portion. In this manner, adjustment of the grip sleeves inserted on the desired positions on the grip skeleton body becomes easier and firmer by the design of interlocking between the adjustment interlocking knob and the adjusting hole.

An embedding hole is further provided on the fixing portion of each adjustment interlocking knob and a sleeve groove for adjusting the insertion of the interlocking portion of the adjustment interlocking knob is provided on the fixing seat. An elastic element is provided between the embedding hole of the interlocking portion and the sleeve groove of the fixing seat. In this manner, the elastic element is fixed between the adjustment interlocking knob and the fixing seat.

### BRIEF DESCRIPTION OF THE DRAWINGS

FIG. 1 is a perspective outline view showing the grip sleeve assembled on the skeleton body of the present invention.

FIG. 2 is a perspective exploded view showing the grip sleeve and the skeleton body of the present invention.

FIG. 3 is a sectional assembled view showing the grip sleeve and the skeleton body of the present invention.

FIG. 4 is a sectional assembled view showing the grip sleeve and the skeleton body of the present invention viewing from another direction.

FIG. 5 is a bottom plan view showing the adjustment interlocking knob of the present invention being pressed to allow the grip sleeve to be separated from the interlocking with the skeleton body in order to conduct adjustment operation.

FIG. 6 is a sectional assembled view showing the adjustment interlocking knob of the present invention being pressed to allow the grip sleeve to be separated from the interlocking with the skeleton body in order to conduct adjustment operation.

FIG. 7 is another sectional assembled view showing the adjustment interlocking knob of the present invention being pressed to allow the grip sleeve to be separated from the interlocking with the skeleton body in order to conduct adjustment operation.

FIG. 8 is a perspective exploded view showing the grip sleeve and the skeleton body of prior art.

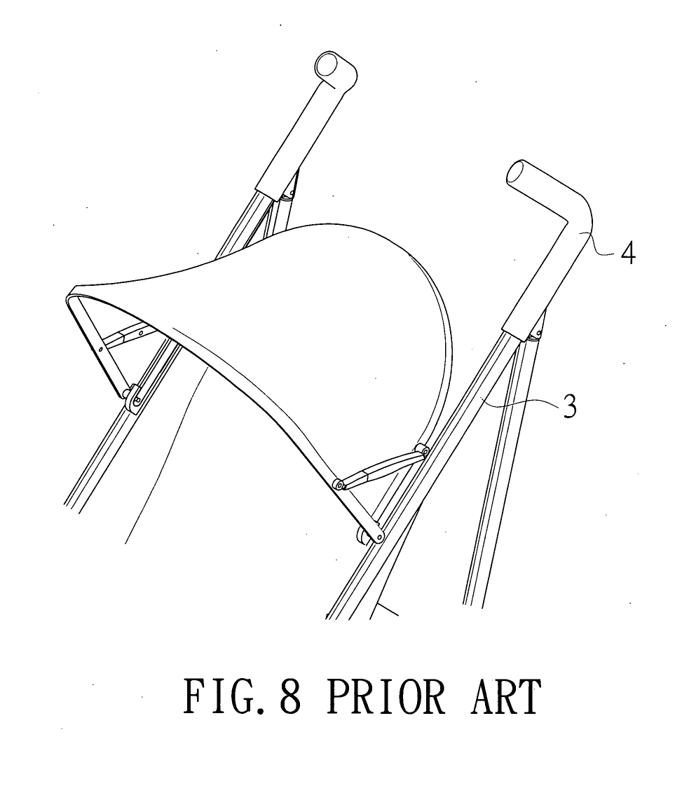

### DETAILED DESCRIPTION OF PREFERRED EMBODIMENT

The objects, the technical contents and the expected effectiveness of the present invention will become more apparent from the detailed description of the preferred embodiment in conjunction with the accompanying drawings.

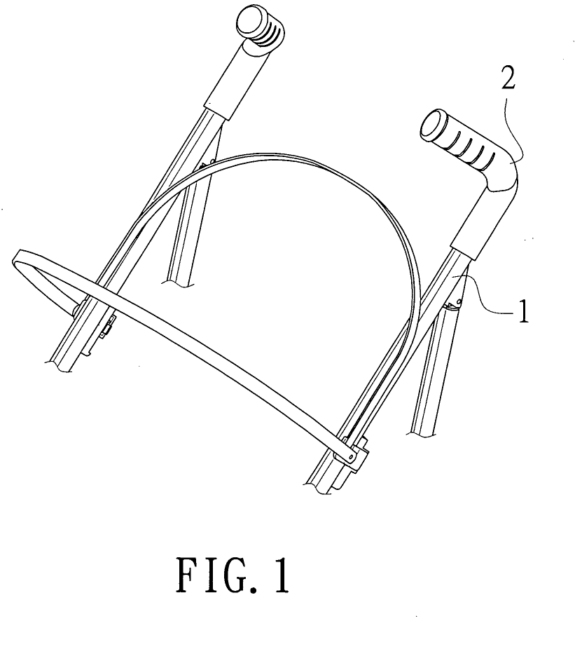

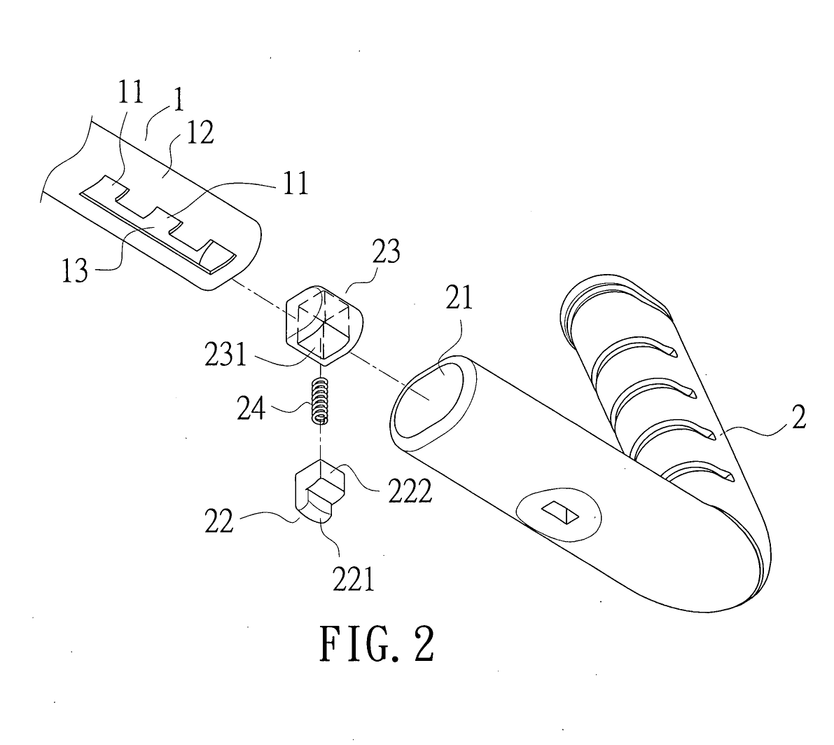

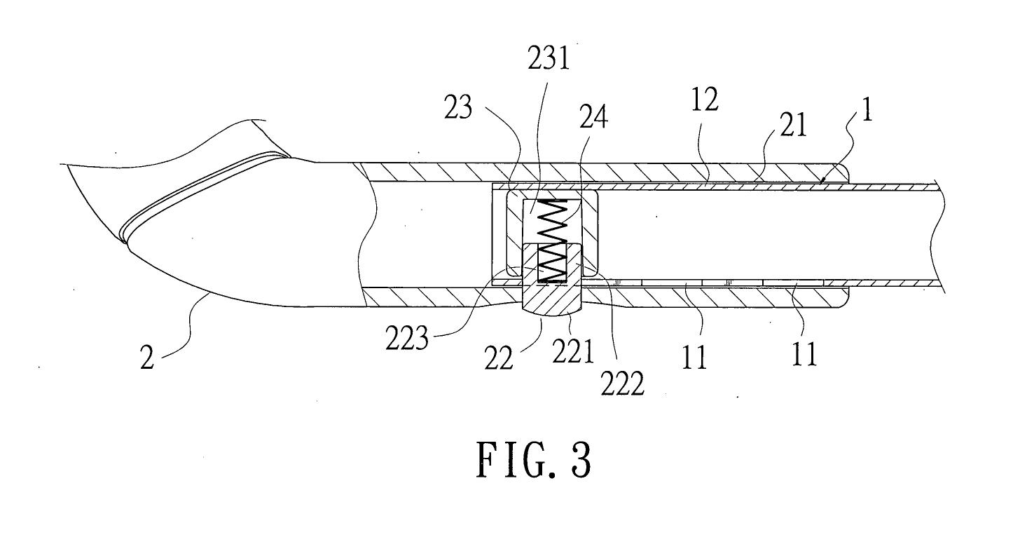

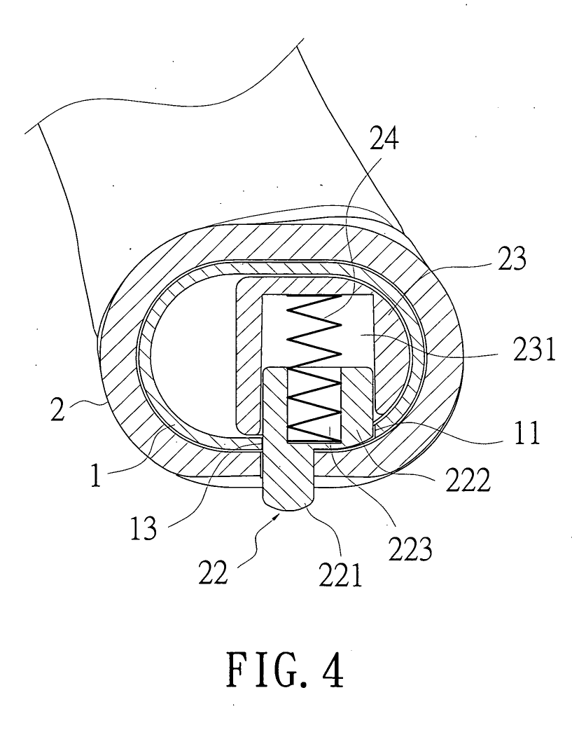

Referring to FIG. 1 to FIG. 4, the skeleton length adjustment structure of grip for baby stroller of the present invention comprises a skeleton body (1) and grip sleeves (2), in which:

The skeleton body (1) has a plurality of adjusting holes (11) provided at the ends thereof;

The grip sleeves (2) have sleeve joint holes (21) respectively which are provided for the insertion from the corresponding skeleton body (1). Each grip sleeve (2) is provided with an adjustment interlocking knob (22) which can be arrested within anyone adjusting hole (11) provided on the skeleton body (1).

According to the skeleton length adjustment structure of grip for baby stroller of the present invention, the adjustment interlocking knob (22) on each grip sleeve (2) is adjusted to be arrested in different adjusting hole (11) on the skeleton body (1) so as to adjust the position of the grip sleeve (2) inserted on the skeleton body (1). Thus, the length of the grip skeleton can be regulated so as to achieve the goal of changing the whole length of the grip skeleton, furthermore to change the distance between the grip sleeve (2) and ground. In this manner, the baby stroller can be regulated to a comfortable height conforming to ergonomics with respect to user pushing the baby stroller.

According to the skeleton length adjustment structure of grip for baby stroller of the present invention, a sleeve joint segment (12) having a plurality of adjusting holes (11) thereon is further provided at each end of the skeleton body (1). The sleeve joint segment (12) is inserted into the sleeve joint hole (21) of each grip sleeve (2).

According to the skeleton length adjustment structure of grip for baby stroller of the present invention, a connecting groove (13) is further connected between two adjacent adjusting holes (11). Each connecting groove (13) is connected at one side of opposite ends of two adjacent adjusting holes (11) so that each connecting groove (13) is leaned to one side of opposite ends of two adjacent adjusting holes (11). Alternatively, each connecting groove (13) is connected at middle part of opposite ends of two adjacent adjusting holes (11) so that each connecting groove (13) is located at the middle position of opposite ends of two adjacent adjusting holes (11). The adjustment interlocking knob (22) has a press portion (221) extending out of the grip sleeve (2) for accepting the press coming from users. The adjustment interlocking knob (22) has an interlocking portion (222), for being arrested into anyone adjusting hole (11) on the skeleton body (1), provided at the other end opposite to press portion (221). The width of each connecting groove (13) is made to be larger than that of the press portion (221) of the adjustment interlocking knob (22) and smaller than that of the interlocking portion (222).

According to the skeleton length adjustment structure of grip for baby stroller of the present invention, a fixing seat (23) is provided at one side of the interlocking portion (222) of each adjustment interlocking knob (22), and an elastic element (24) generating a force for urging the fixing seat (23) and the adjustment interlocking knob (22) outwardly is provided therebetween.

An embedding hole (223) is provided on the interlocking portion (222) of the adjustment interlocking knob (22) and the fixing seat (23) has a sleeve groove (231) for the accommodation of the interlocking portion (222). The elastic element (24) is provided between the embedding hole (223) and the sleeve groove (223). In this manner, the elastic element (24) is fixed between the adjustment interlocking knob (22) and the fixing seat (23).

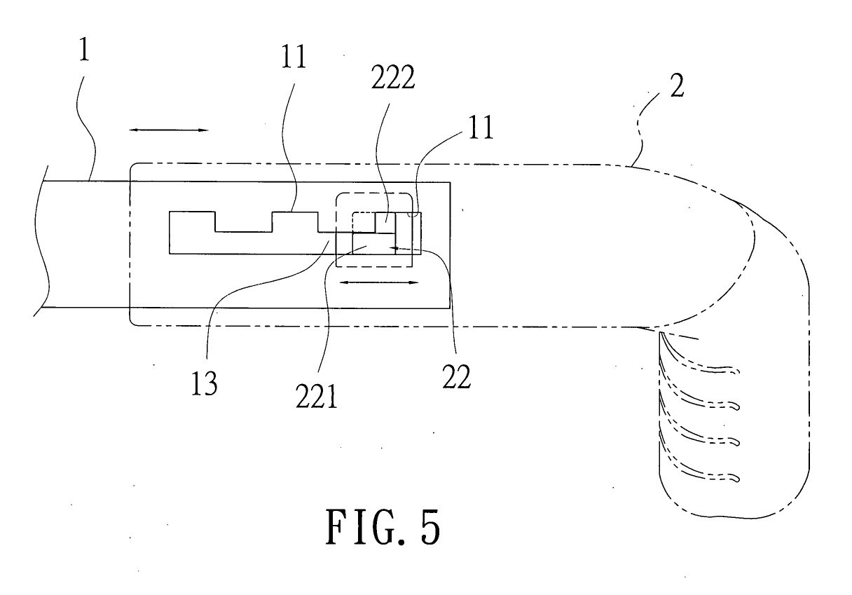

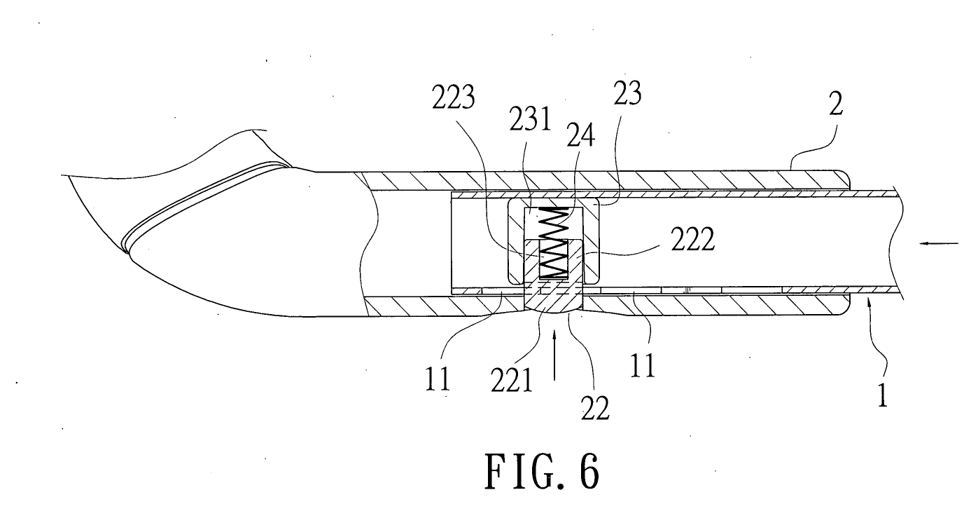

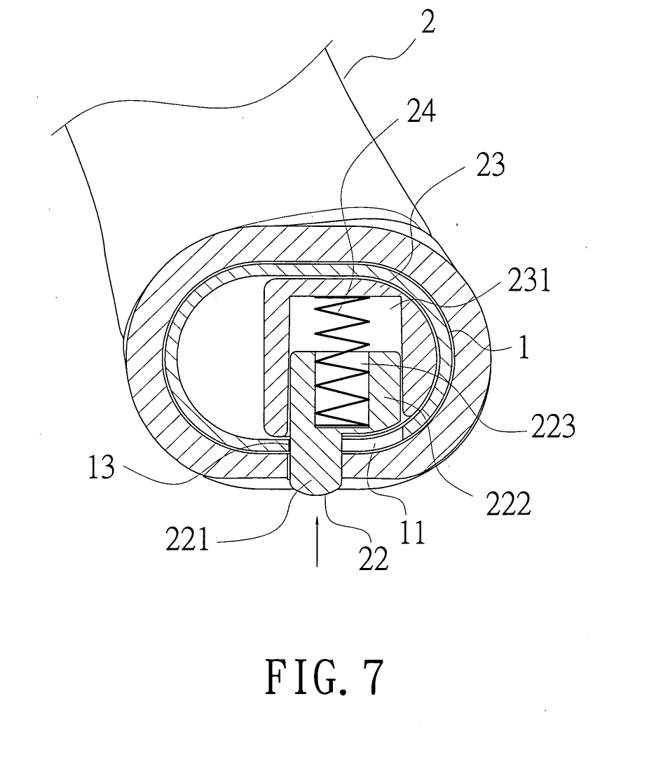

Referring to FIGS. 5, 6, 7, when the position of the grip sleeves (2) on the skeleton body (1) are to be regulated, the press portion (221) of the adjustment interlocking knob (22) on each grip sleeve (2) is pressed directly such that the interlocking portion (222) of the adjustment interlocking knob (22) is fallen into the skeleton body (1) and is separated from some adjusting hole (11) of the skeleton body (1). After the grip sleeve (2) is further moved to expected position, the adjustment interlocking knob (22) is released and the interlocking portion (222) of the adjustment interlocking knob (22) is inserted into another adjusting hole (11) of the skeleton body (1) under the action of restoring force of the elastic element (24) so that the adjustment of the position of the grip sleeve (2) on the skeleton body (1) is thus completed. As two adjacent adjusting holes (11) is connected by the connecting groove (13) and the width of the connecting groove (13) is larger than that of the press portion (221) and smaller than that of the interlocking portion (222), the adjustment interlocking knob (22) can move between the adjusting hole (11) and the connecting groove (13) to conduct length regulation of the grip skeleton, when the adjustment interlocking knob (22) is pressed to allow the interlocking portion (222) separate from the adjusting hole (11). Furthermore, as the interlocking portion (222) of the adjustment interlocking knob (22) is accommodated within the sleeve groove (231), a guiding mechanism for the actuation of the adjustment interlocking knob (22) is thus formed such that the pressing operation of the adjustment interlocking knob (22) can be conducted more smoothly.

While the present invention has been described by the above preferred embodiment, it is understood that the above preferred embodiment is not used to restrict the product structure or usage mode of the present invention. Variations and modifications made without departing from the spirit and features of the present invention are still considered to be within the scope of the present invention.

What is claimed is:

1. A skeleton length adjustment structure of grip for baby stroller, comprising:
a skeleton body the ends of which are inserted with grip sleeves and are provided with a plurality of adjusting holes respectively;
grip sleeves having sleeve joint holes which are provided for the insertion by the sleeve joint segments of the skeleton body, each said grip sleeve having an adjustment interlocking knob which can be arrested into anyone adjusting hole on the skeleton body, said adjustment interlocking knob having a press portion extending out of the grip sleeve and an interlocking portion for being arrested into anyone adjusting hole on the skeleton body, and the width of a connecting groove for connecting two adjacent adjusting holes being set to be larger than that of the press portion of the adjustment interlocking knob and being smaller than that of the interlocking portion thereof, a fixing seat being provided at one side of the interlocking portion of said adjustment interlocking knob and an elastic element generating a force for urging said adjustment interlocking knob and the fixing seat outwardly being provided therebetween.

2. A skeleton length adjustment structure of grip for baby stroller as claimed in claim 1, wherein sleeve joint segments, each having a plurality of adjusting holes disposed thereon, are further provided at the ends of the skeleton body, the sleeve joint segments being inserted into the sleeve joint holes of the grip sleeves.

3. A skeleton length adjustment structure of grip for baby stroller as claimed in claim 2, wherein a connecting groove is connected between two adjacent adjusting holes.

4. A skeleton length adjustment structure of grip for baby stroller as claimed in claim 3, wherein each connecting groove is connected at one side of opposite ends of two adjacent adjusting holes so that each connecting groove is leaned to one side of opposite ends of two adjacent adjusting holes.

5. A skeleton length adjustment structure of grip for baby stroller as claimed in claim 3, wherein each connecting groove is connected at middle part of opposite ends of two adjacent adjusting holes so that each connecting groove is located at the middle position of opposite ends of two adjacent adjusting holes.

6. A skeleton length adjustment structure of grip for baby stroller as claimed in claim 1, wherein an embedding hole is provided on the interlocking portion of each adjustment interlocking knob and a sleeve groove is provided on each fixing seat, each sleeve groove being inserted into the embedding hole on the interlocking portion of the adjustment interlocking knob after the elastic element is inserted therein, so that the elastic element is fixed between the adjustment interlocking knob and the fixing seat, simultaneously the interlocking portion of each adjustment interlocking knob being also located within the sleeve groove of the fixing seat.
